(19) United States
(12) Patent Application Publication
(10) Pub. No.: US 2008/0157626 A1
(43) Pub. Date: Jul. 3, 2008

(54) Novel layout design for micro scratch drive actuator

(75) Inventors: Alex Horng, Kaohsiung City (TW); I-Yu Huang, Kaohsiung City (TW); Yen-Chi Lee, Kaohsiung City (TW); Chun-Ying Lin, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/797,243

(22) Filed: May 2, 2007

(30) Foreign Application Priority Data
Dec. 28, 2006 (TW) 95149594

(51) Int. Cl. H02N 11/00

(52) U.S. Cl. 310/300

(57) ABSTRACT

To improve the yield, lifetime and driving voltage of the micro scratch drive actuator (SDA), this invention proposes a novel layout design including the etch holes and flange structure designs.

Once the etch holes added to the layout of conventional SDA plate, the releasing of structure layer can be accelerated and the accumulated residual charges in the front end of SDA plate is reduced. In this innovative design, a longer lifetime and lower driving voltage of the SDA device can be achieved. On the other hand, adding the flange structure design in the corner of the beam-to-plate conjunction can improve the flexural rigidity of the narrow polysilicon supporting beam which will further enhance the yield of the SDA device and reduce the crack failure under actuating situation.

### FIELD OF THE INVENTION

This invention presents a novel layout design for yield improvement, power reduction and lifetime enhancement of micro scratch drive actuator. The major technology adopted in this patent is the polysilicon-based surface micromachining process of microelectromechanical systems (MEMS) technology, with the advantages of batch fabrication, low cost and high compatibility with integrated circuit technology.

### BACKGROUND OF THE INVENTION

The development and application of the miniaturization technology is the major trend of modern science. In particular, the integrated circuits (IC) and microelectromechanical systems (MEMS) technologies are the rudimentary methods of the microscopic world in the recent years. The smallest micro fan device in the world with dimension of 2 mm×2 mm (as shown in Appendix 1) is actuated by micro scratch-drive actuators (SDAs) and fabricated by using polysilicon based surface micromachining technology (multi-user MEMS processes, MUMPs) as Appendix 2 shows. The conventional miniaturized micro fan chip is constructed by self-assembly micro blades and micro SDAs (as Appendix 1 and Appendix 3 show). This patent aims to present a novel layout design of the micro SDA-based devices for product yield improvement, manufacturing cost-down, power consumption reduction and device lifetime enhancement.

The basic optimized dimension of the micro SDA plate has been demonstrated in the previous literatures (reported by R. J. Linderman & V. M. Bright) as 78 μm-length and 65 μm-width by simulation software and experimental measurements. In such design, the SDA can obtain many excellent performances. However, none of the reports or researches have mentioned about the influences of the SDA-plate shape, etch holes and the flange of supporting beam. The conventional SDA plate fabricated by MEMS technology has the following three types: (i) triangle type, (ii) rectangle type and (iii) hexagonal type, as shown in FIG. 1, where the red circles represent the dimple layout designed for the friction decreasing.

The triangle-type SDA is the most frequently adopted due to its smaller free-end dimension under the same plate length. Thus the amount of the residual charges accumulated in the free-end area of SDA plate can substantially decrease, hence the stiction effect result from those charges can be effectively controlled and the lifetime can be improved.

However, triangle-type SDA plate has smaller area than the others, thus it needs a higher bias (power) to deflect and actuate the plate. In the other words, rectangular type SDA plate has lower power consumption but shorter lifetime. The third type of traditional SDA plate is hexagonal type, processes moderate characteristics between triangle and rectangular type. In this patent, a novel etch holes added in the layout design of rectangular and hexagonal type SDA plate to accelerate the release of structure layer and reduce the charges accumulated in the front end of SDA plate. In this innovative design, a longer lifetime and lower driving voltage of the SDA device can be achieved.

Typical SDA-based micro motor is fabricated by using surface micromachining technology. After releasing process, the floating SDA plate is connected to the main structure of SDA motor through the polysilicon supporting beam. When the moderate driving voltage is applied, a combined torques resulted from the electrostatic force between the supporting beam and SDA plate with the substrate respectively will actuate the SDA move forward. In detail, according to the descriptions of Bright and Linderman, the stepwise motion begins with the free end of SDA-plate electrostatically loaded with the snap through voltage resulting in the plate tip snapping down to touch the nitride dielectric layer. When the power increased to the priming voltage, the plate tip will be deflected enough and flattened to a zero slope at the free end. Finally, as the applied power was removed, the strain energy stored in the supporting beams, SDA-plate and bushing will pull the SDA-plate forward to complete the step.

However, the width of the supporting polysilicon beam designed in previous literatures or technical reports only measures about 2˜3 μm, which is smaller than the dimension of SDA plate and thus can contribute a very limited torque. Furthermore, the narrow polysilicon beam usually suffer the undercutting effect during the wet etching or sacrificial layer release process which will further reduce the device yield and increase the crack failure under actuating situation. In this invention, this defect can be improved by adding the flange structure design in the corner of the beam-to-SDA plate and beam-to-SDA trail conjunctions.

### SUMMARY OF THE INVENTION

To improve the fabricating yield, lifetime and driving voltage of the micro scratch drive actuators, this invention proposes a novel layout including the etch holes and flange structure design. When the etch holes was added in the layout design of the conventional rectangular and hexagonal type SDA plate, the releasing of structure layer can be accelerated and the accumulated residual charges in the front end of SDA plate and the friction between SDA plate and substrate can be substantially decreased since the effective area of SDA plate is reduced. In this innovative design, a longer lifetime and lower driving voltage of the SDA device can be achieved. On the other hand, adding the flange structure design in the corner of the beam-to-SDA plate and beam-to-SDA trail conjunctions can improve the flexural rigidity of the narrow polysilicon beam which will further enhance the device's yield and reduce the crack failure under actuating situation. In summary, the low yield, higher driving voltage and shorter lifetime characteristics of the conventional SDA can be improved and be optimized by using the new-type layout design proposed in this patent.

### DETAILED DESCRIPTION OF THE PREFERRED EMBODIMENT

The novel layout designs proposed in this patent are shown in FIG. 2 and FIG. 3, which can effectively reduce the accumulated residual charges and substantially increase the flexural rigidity of the supporting beam. In this innovative design, a longer lifetime and lower driving voltage of the SDA device can be achieved.

FIG. 4 shows the SEM (Scanning Electron Microscope) micrograph of the implemented free-standing SDA device with etch holes and flange structure designs. The complete layout design of the micro SDA at least requires five photomasks and the major fabricating technology adopted in this invention is the polysilicon-based surface micromachining processes.

To investigate the optimized geometric parameters of the SDA plate, this patent has compared the influence of driving voltage on three different shapes and four length/width ratios of SDA-plate. In the testing results as depicted in FIG. 5, triangle SDA plate has higher driving voltage than the rectangle shape. Although the SDA-plate added with etching-holes can accelerate the release of structure layer and reduce the accumulated charges, however, it will slightly increase the driving voltage of SDA micromotor. The optimized dimension of the SDA-plate is clearly indicated in FIG. 5. When the ratio of plate length and plate width is equal to 78/65, the smallest driving voltage can be obtained.

### BRIEF DESCRIPTION OF THE DRAWINGS

FIG. 1 is a schematic diagram showing three different layout designs of the conventional scratch drive actuator.

FIG. 2 is a schematic diagram showing the new “etch-holes added” layout design of SDA-plate presented in this invention.

FIG. 3 is a schematic diagram showing the new “flange” structure design of SDA-plate's supporting beam presented in this invention.

FIG. 4 is a SEM micrograph showing the implemented free-standing SDA device with etch holes layout and flange structure designs.

FIG. 5 is an illustration showing the influence of driving voltage on three different shapes and four length/width ratios of SDA-plate

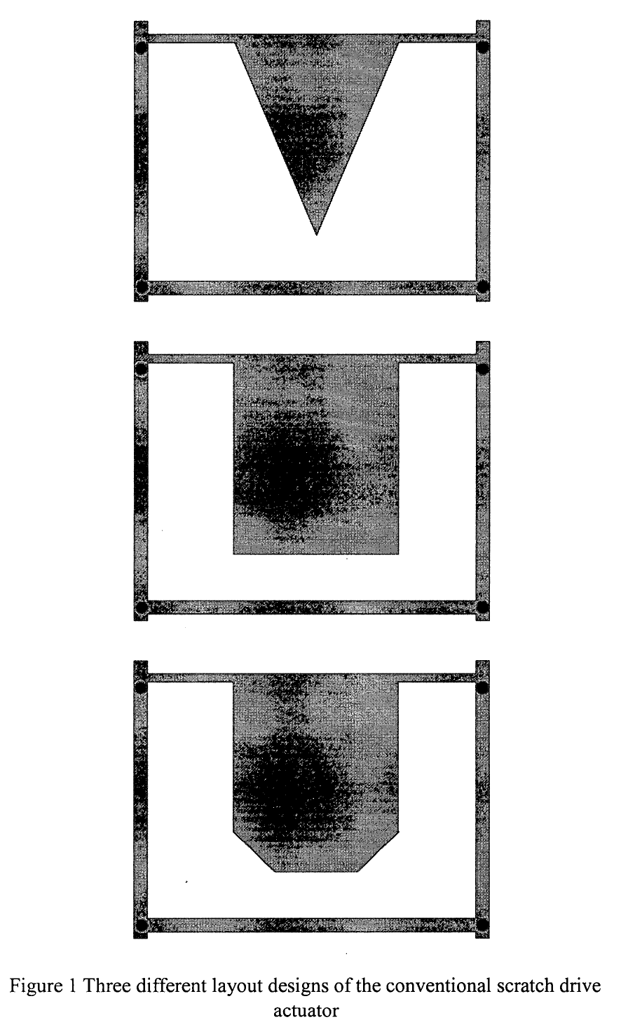

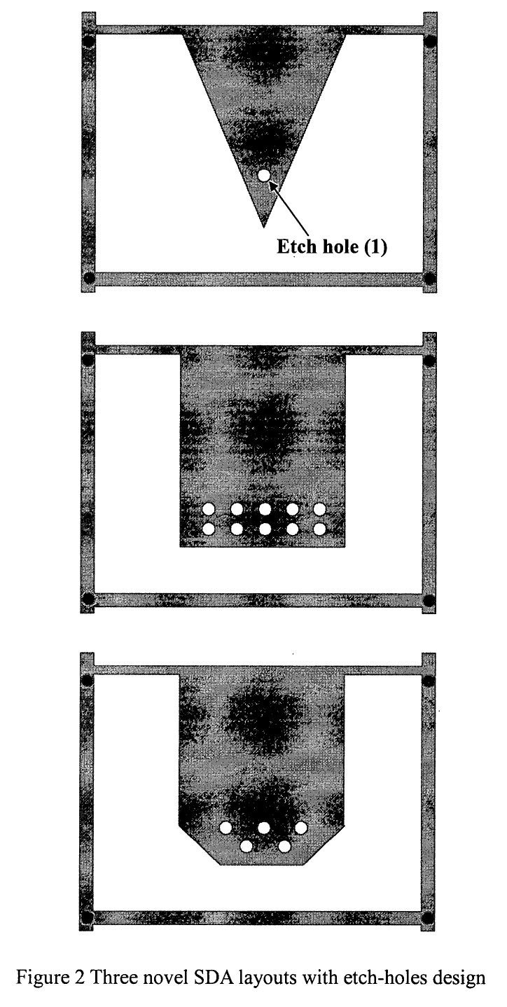

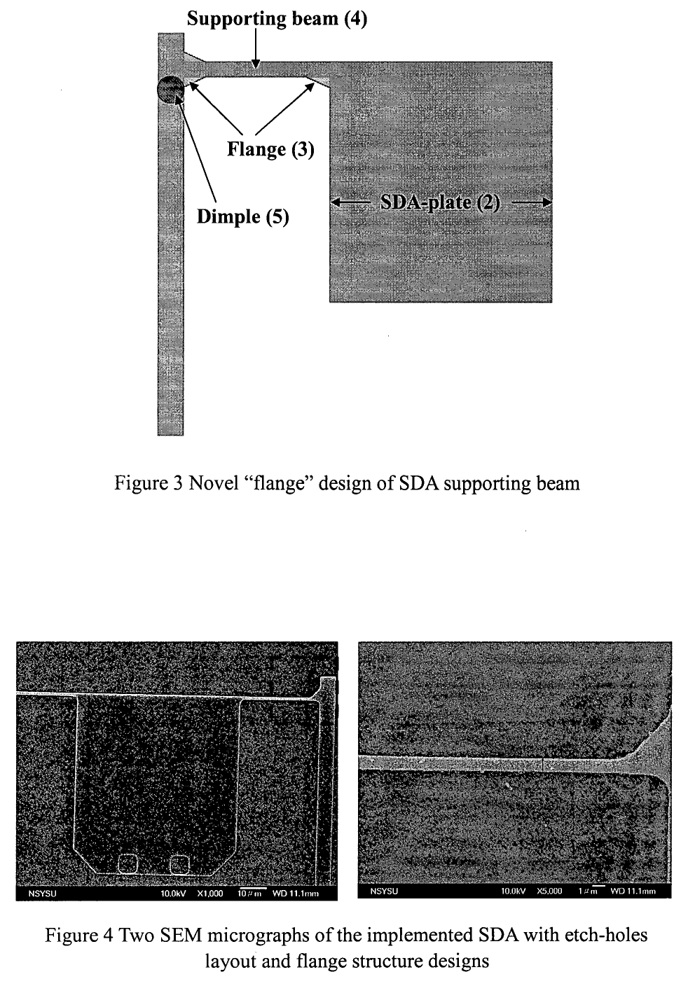

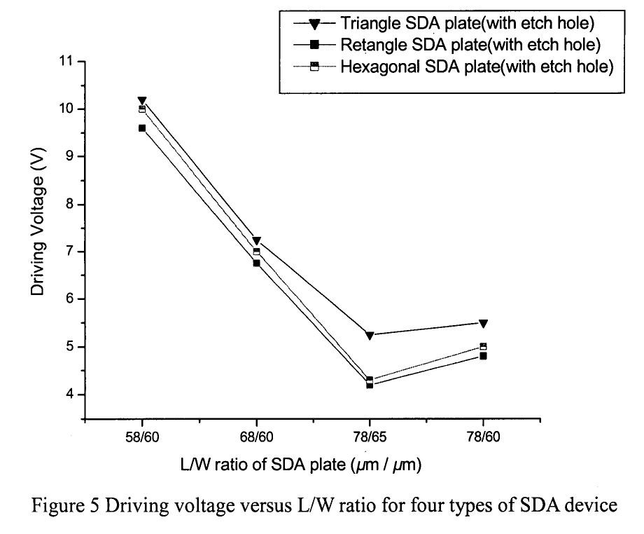

What is claimed is:

1. An innovative layout of micro scratch drive actuators, including:
at least three new shapes of SDA plate, including the triangle SDA plate with etch-holes design, rectangle SDA plate with etch-holes design and hexagonal SDA plate with etch-holes design. Once the etch holes added to the layout of conventional SDA plate, the releasing of structure layer can be accelerated and the accumulated residual charges in the front end of SDA plate is reduced, and
at least a new “flange” structure design of SDA-plate supporting-beam. Adding the flange structure design in the corner of the beam-to-plate conjunction can improve the flexural rigidity of the narrow polysilicon supporting beam which will further enhance the yield of the SDA device and reduce the crack failure under actuating situation, and
at least four different length/width ratio of SDA-plate have been designed in this patent, including 58 μm/60 μm, 68 μm/60 μm, 78 μm/60 μm and 78 μm/65 μm.

2. The SDA device with the novel layout and structure designs as mentioned in claim 1 can be fabricated on an ultra-low-resistivity silicon wafer (0.001˜0.004 Ω-cm) to further decrease the driving voltage.

3. The SDA device with the novel layout and structure designs as mentioned in claim 1 can be applied to the development of SDA micro motor.

4. The SDA device with the novel layout and structure designs as mentioned in claim 1 can be applied to the development of SDA-based micro fan.

5. The SDA device with the novel layout and structure designs as mentioned in claim 1 can be applied to the development of micro thermal module/system assembly.

6. The SDA device with the novel layout and structure designs as mentioned in claim 1 can be applied to the development of micro device/structure assembly.

7. The SDA device with the novel layout and structure designs as mentioned in claim 1 can be applied to the development of micro fluid system.

8. The SDA device with the novel layout and structure designs as mentioned in claim 1 can be applied to the development of optical/telecommunication micro switch.
